(19) United States
(12) Patent Application Publication
(10) Pub. No.: US 2026/0239249 A1
(43) Pub. Date: Aug. 13, 2026

(54) USER EQUIPMENT BASED TIMING ADVANCE ESTIMATION

(71) Applicant: Apple Inc., Cupertino, CA (US)

(72) Inventors: Naveen Kumar R. Palle Venkata, San Diego, CA (US); Qiming Li, Beijing (CN); Fangli Xu, Beijing (CN); Hong He, San Jose, CA (US); Haijing Hu, Los Gatos, CA (US); Yuqin Chen, Beijing (CN); Zhibin Wu, Los Altos, CA (US); Ralf Rossbach, Munich (DE); Ping-Heng Kuo, London (GB); Peng Cheng, Beijing (CN)

(73) Assignee: Apple Inc., Cupertino, CA (US)

(21) Appl. No.: 19/470,986

(22) PCT Filed: Apr. 5, 2023
(86) PCT No.: PCT/CN2023/086351

§ 371 Date: Sep. 30, 2025

(51) Int. Cl. H04W 56/00; H04L 5/00

(52) U.S. Cl. CPC H04W 56/0045; H04L 5/0048; H04W 56/0065

(57) ABSTRACT

The present application relates to techniques for UE-based TA estimations. For example, a UE can be connected to a base station via a first cell and can be configured with information for a UE-based TA estimation. This information can be included in a cell configuration of a second cell, a group configuration of a group of cells, or a measurement configuration. The UE can perform a first timing measurement on a first reference signal sent by the first cell and a second timing measurement on a second reference signal sent by the second cell. Upon a command to connect to the second cell (e.g., for a first cell to second cell handover), the UE can determine a timing difference between the two timing measurements and determine, based on a first TA of the first cell and the timing difference, a second TA to use for the second cell.

Cellular communications can be defined in various standards to enable communications between a user equipment (UE) and a cellular network. For example, Fifth generation mobile network (5G) is a wireless standard that aims to improve upon data transmission speed, reliability, availability, and more. Cellular coverage is a relevant feature for data transmission. The UE may be instructed to establish connections with different cells of the cellular network to maintain the cellular coverage. Timing advance (TA) relates to the timing of UE transmission over a cell.

### BRIEF DESCRIPTION OF THE DRAWINGS

FIG. 1 illustrates an example of a network environment, in accordance with some embodiments.

FIG. 2 illustrates an example of a network coverage based on a base station and cells provided by such a base station, in accordance with some embodiments.

FIG. 3 illustrates an example of a user equipment (UE) based timing advance (TA) estimation, in accordance with some embodiments.

FIG. 4 illustrates an example of a procedure related to a UE-based TA estimation, in accordance with some embodiments.

FIG. 5 illustrates an example of information indicated in a RRC configuration for a UE-based TA estimation, in accordance with some embodiments.

FIG. 6 illustrates examples of information indicated in a RRC configuration for a UE-based TA estimation, in accordance with some embodiments.

FIG. 7 illustrates another example of information indicated in a RRC configuration for a UE-based TA estimation, in accordance with some embodiments.

FIG. 8 illustrates an example of a command to trigger using timing measurements for computing a TA, in accordance with some embodiments.

FIG. 9 illustrates an example of indicating a capability of a UE for supporting a UE-based TA estimation, in accordance with some embodiments.

FIG. 10 illustrates an example of a command for correcting a UE-based TA estimation, in accordance with some embodiments.

FIG. 11 illustrates an example of an operational flow/algorithmic structure implemented by a UE to perform a UE-based TA estimation, in accordance with some embodiments.

FIG. 12 illustrates an example of an operational flow/algorithmic structure implemented by a network to trigger a UE-based TA estimation, in accordance with some embodiments.

FIG. 13 illustrates an example of receive components, in accordance with some embodiments.

FIG. 14 illustrates an example of a UE, in accordance with some embodiments.

FIG. 15 illustrates an example of a base station, in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art, having the benefit of the present disclosure, that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

Generally, a user equipment (UE) communicates with a network when the UE is in a network coverage of the network. The network coverage can be provided via cells of the network. The UE can be connected to a first cell and can receive a command to connect to a second cell (e.g., a handover from the current serving cell to a new serving cell). Rather than the network providing a timing advance (TA) for the second cell, the UE can perform a UE-based TA estimation to determine this TA. In particular, the UE can perform a first time measurement on a first reference signal of the first cell and a second time measurement on a second reference signal of the second cell and determine a timing difference between these two measurements. The UE-based estimation can further include determining the TA to use for the second cell as a function of the TA of the first cell and the timing difference (e.g., as their sum). The UE can transmit data over a connection with the second cell (e.g., uplink frames), where the uplink transmission is timed according to the estimated TA.

To be able to perform and use the UE-based TA estimation, the UE can be configured (e.g., via radio resource control (RRC) signaling) with information about measurement objects and/or candidate cells for which the UE-based TA estimation can be performed. These cells include the second cell, and their operations are generally time-synchronized (although the UE need not be aware of the time synchronization). This configuration information can be available to the UE prior to the command to connect to the second cell. Upon certain measurement criteria being met (e.g., a reference signal received power and/or a reference signal received quality associated with the first cell falling below a threshold(s)), the UE can detect the second cell and, based on a determination that the second cell is a candidate cell for the UE-based time estimation, perform the time measurement on the second reference signal. Upon receiving the command, the UE can determine that the command indicates the second cell and can complete the estimation of the TA to use for the second cell. By doing so, the UE-based TA estimation can be enabled, thereby avoiding the need for network-based TA to be provided to the UE (e.g., as part of a random access channel (RACH) procedure). Because the UE-based TA estimation can be performed in a faster manner than the procedure for the network-based TA, the overall mobility latency and throughput can be improved. These and other aspects of the present disclosure are described herein below.

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, device, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The UE may have a primary function of communication with another UE or a network and the UE may be integrated with other devices and/or systems (e.g., in a vehicle).

The term “base station” as used herein refers to a device with radio communication capabilities, that is a device of a communications network (or, more briefly, network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network.

The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refer to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

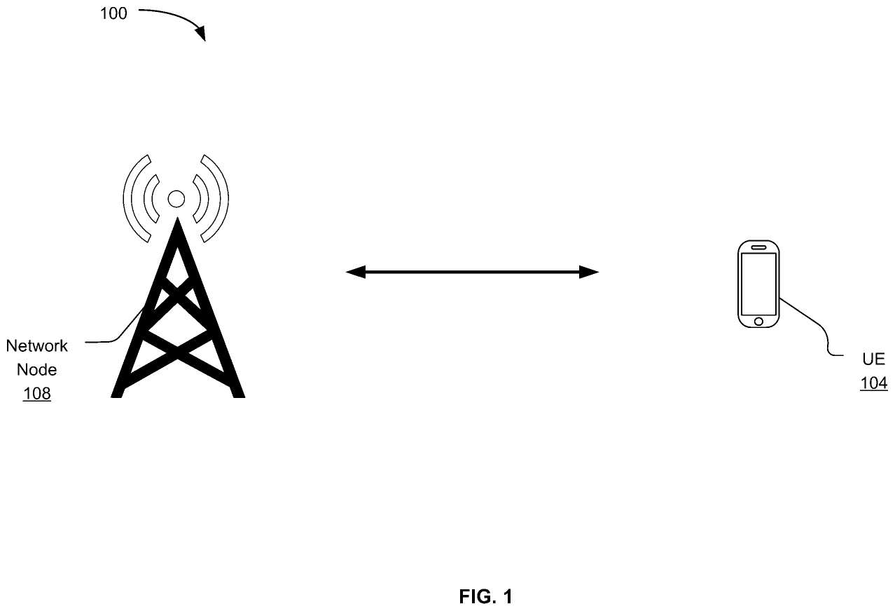

FIG. 1 illustrates a network environment 100, in accordance with some embodiments. The network environment 100 may include a UE 104 and a network node 108. The network node 108 may be a base station that provides a wireless access cell; for example, a Third-Generation Partnership Project (3GPP) New Radio (NR) cell, through which the UE 104 may communicate with the network node 108. This base station may be a component of a terrestrial network. The UE 104 and the network node 108 may communicate over an interface compatible with 3GPP technical specifications, such as those that define Fifth Generation (5G) NR system standards.

The network node 108 may transmit information (for example, data and control signaling) in the downlink direction by mapping logical channels on the transport channels, then transport channels onto physical channels. The logical channels may transfer data between a RLC and MAC layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the network node 108 to allocate both uplink and downlink resources. The DCI may also be used to provide uplink power control commands, configure a slot format, or indicate that preemption has occurred.

The network node 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include CSI-RS. The CSI-RS may be a multi-purpose downlink transmission that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

Transmissions that use different antenna ports may experience different radio channels. However, in some situations, different antenna ports may share common radio channel characteristics. For example, different antenna ports may have similar Doppler shifts, Doppler spreads, average delay, delay spread, or spatial receive parameters (for example, properties associated with a downlink received signal angle of arrival at a UE). Antenna ports that share one or more of these large-scale radio channel characteristics may be said to be quasi co-located (QCL) with one another. 3GPP has specified four types of QCL to indicate which particular channel characteristics are shared. In QCL Type A, antenna ports share Doppler shift, Doppler spread, average delay, and delay spread. In QCL Type B, antenna ports share Doppler shift and Doppler spread. In QCL Type C, antenna ports share Doppler shift and average delay. In QCL Type D, antenna ports share spatial receiver parameters.

The network node 108 may provide transmission configuration indicator (TCI) state information to the UE 104 to indicate QCL relationships between antenna ports used for reference signals (for example, synchronization signal/PBCH or CSI-RS) and downlink data or control signaling (for example, PDSCH or PDCCH). The network node 108 may use a combination of RRC signaling, MAC control element signaling, and DCI, to inform the UE 104 of these QCL relationships.

The UE 104 may transmit data and control information to the network node 108 using physical uplink channels. Different types of physical uplink channels are possible, including a physical uplink control channel (PUCCH) and a physical uplink shared channel (PUSCH). Whereas the PUCCH carries control information from the UE 104 to the network node 108, such as uplink control information (UCI), the PUSCH carries data traffic (e.g., end-user application data) and can carry UCI.

In an example, communications with the network node 108 and/or the base station can use channels in the frequency range 1 (FR1) band (between 40 Megahertz (MHz) and 7,125 MHz) and/or frequency range 2 (FR2) band (between 24,250 MHz and 52,600 MHz), although other frequency ranges are possible (e.g., a frequency range having a frequency larger than 52,600 MHz). The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

In an example, the network node 108 is a base station that includes a CU and/or one or more DUs. In this example, the network coverage provided to the UE 104 can change over time and/or depending on the UE's 104 location. An inter-DU mobility procedure or an intra-DU mobility procedure can be performed to support mobility of the UE 104 and provide the proper network coverage.

In particular, a DU can provide multiple cells (e.g., each via a transmission and reception point (TRP) connected to the DU). The DU can tightly synchronize the clocks of these cells such that their TAs can be time-synchronized. As such, these cells can be candidate cells for a UE-based TA estimation. In the context of Layer 1 (L1)/Layer 2 (L2) mobility, such cells can be referred to as L1/L2 triggered mobility (LTM) cells that are candidate cells for a UE-based TA estimation.

The UE 104 can be camped in a serving cell. The base station can configure the UE 104 with multiple candidate LTM cells for a UE-based TA estimation. For instance, the base station can configure the UE 104 with groups of candidate LTM cells using one or more RRC messages, where each group is provided by a DU of the base station.

In some instances, there can be a connection issue between the UE 104 and the serving cell, such as a radio link failure or a degradation in the signal quality. In response to the connection issue, the UE 104 can search neighboring cells to establish a connection with a target cell from a group of candidate cells. The candidate cells can include some or all of the candidate LTM cells. In some instances, the candidate LTM cells can have priority over candidate non-LTM cells. The procedure to determine a TA for the target cell can depend on the selected target cell.

In particular, if the target cell is a candidate LTM cell that belongs to the same group as the serving cell, the UE can perform the UE-based TA estimation to determine the TA. If the target cell is a candidate non-LTM cell or is a candidate LTM cell that belongs to a different group than the serving cell, the UE may not perform the UE-based TA estimation. Instead, the UE can receive a network-based TA (e.g., a TA sent by the base station). Examples of LTM cells and related TA information are described in the next figures.

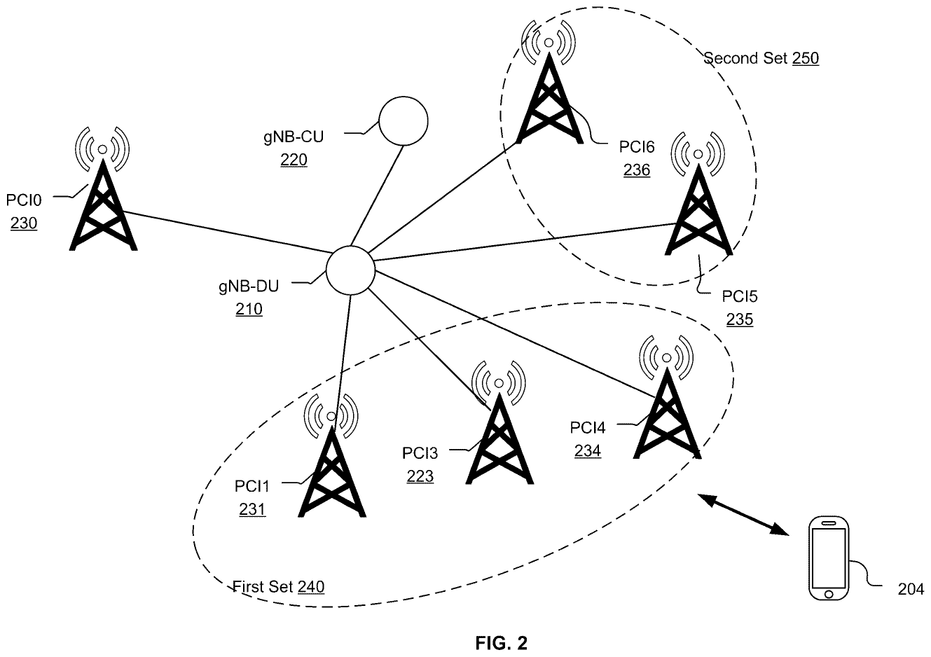

FIG. 2 illustrates an example of a network coverage based on a base station and cells provided by such a base station, in accordance with some embodiments. The network can include the base station (which is an example of the network node 108) and can be in communication with a UE 204 (which is an example of the UE 104) via the base station. The base station can include a CU and/or one or more DUs. In some embodiments, the base station may be a gNB, eNB and so on. In the example of FIG. 2, the base station is illustrated as a gNB. In such an example, a CU of a gNB may be referred to as a gNB-CU, and a DU of the gNB may be referred to as a gNB-DU.

For illustrative purposes, FIG. 2 illustrates a gNB-DU 210 and a gNB-CU 220. The gNB-DU 210 is connected to the gNB-CU 220 (although additional gNB-DU(s) can be connected to the gNB-CU 220 and/or the gNB-CU 220 can be connected to additional gNB-CU(s) of the network). Operations of the gNB-DU 210 may be partly controlled by the gNB-CU 220. The gNB-CU 220 may terminate an F1 interface connected with the gNB-DU 210. The gNB-DU 210 may terminate an F1 interface connected with the gNB-CU 220.

The gNB-CU 220 may be a logical node hosting at least one of RRC, service data adaption protocol (SDAP), and packet data convergence protocol (PDCP) protocols of a base station. The gNB-DU 210 may be a logical node hosting at least one of RLC, MAC, and physical (PHY) layers of the base station. The gNB-DU 210 may provide or support one or more cells. One cell is supported by only one DU. For example, the gNB-DU 210 may provide cells 230 (having a physical cell ID “0” shown as PCI0), 231 (having a physical cell ID “1” shown as PCI1), and 233 (having a physical cell ID “3” shown as PCI3), 234 (having a physical cell ID “4” shown as PCI4), 235 (having a physical cell ID “5” shown as PCI5), and 236 (having a physical cell ID “6” shown as PCI6). Each cell can be provided by a TRP connected to the gNB-DU 210. As used herein, a cell can refer to components of a TRP and/or of a base station, where these components enable communications with a UE.

The cells 230-236 can be configured as candidate LTM cells for the UE 204. As further illustrated in FIG. 2, two sets of the cells 230-236 are time-synchronized: a first set 240 that includes cells 231-234, and a second set 250 that includes cells 235-236. The cell 230 is not time synchronized with any of the remaining cells. In particular, the clocks of the TRPs of the cells 231-234 can be tightly controlled (e.g., by the gNB-DU 210 and/or the gNB-CU 220) such that time differences between the clocks of the TRPs are known to the network (e.g., to gNB-DU 210 and/or the gNB-CU 220) and, possibly, minimal, reduced, or eliminated. Similarly, the clocks of the TRPs of the cells 235-236 can be tightly controlled (e.g., by the gNB-DU 210 and/or the gNB-CU 220) such that time differences between the clocks of the TRPs are known to the network. The clock synchronization of the first set 240, the clock synchronization of the second set 250, and the clock synchronization associated with cell 230 need not tightly coordinated.

It is to be understood that the numbers of UEs, CUs and DUs and the groupings of LTM cells are only for the purpose of illustration without suggesting any limitations to the present disclosure. The network may include any suitable number of UEs, CUs and DUs adapted for implementing implementations of the present disclosure.

The communications in the network may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like.

Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

Using the illustration of FIG. 2, the UE 204 is connected (e.g., in a CONNECTED mode) with a serving cell. The UE 204 can then establish a second connection with a target cell (e.g., in a handover to a new serving cell). If the target cell and the serving cell are in the same set (e.g., the first set 240 or the second set 250), the UE 204 can perform a UE-based TA estimation given the coordinated time differences. If the target cell and the serving cell are not in the same set (e.g., one of the cells is in the first set 240, whereas the other set is in the second set 250 or is the cell 230), the UE-based TA estimation may not be performed.

In an example, the UE 204 may access one cell provided by the gNB-DU 210. For instance, the UE 204 may be initially connected to the cell 234. Based on measurements, the UE 204 may perform an intra-DU mobility procedure so as to move from the cell 234 to another cell provided by the first gNB-DU 210. For example, the UE 204 may perform an intra-DU mobility procedure so as to move in a first case to one of the cells 231 or 233 in the first set 240, or to move in a second case to one of the cells 235 or 236 of the second set 250. Hereinafter, the intra-DU mobility is also referred to as intra-gNB-DU mobility.

Alternatively, based on measurements, the UE 204 may perform an inter-DU mobility procedure so as to move, in the third case, from the cell 234 provided by the gNB-DU 210 to a cell provided by another gNB-DU connected to the gNB-CU. Hereinafter, the inter-DU mobility is also referred to as inter-gNB-DU mobility.

In the first case, the UE-based TA estimation can be performed. In the second and third cases, the UE-based TA estimation should not be performed.

In some embodiments, the UE 204 may be in dual connectivity (DC) with the gNB-CUs 220. The intra-DU mobility procedure and the inter-DU mobility procedure may be allowed when the gNB-CU 220 is configured as a secondary node (SN) in a DC configuration while the gNB-CU 240 is configured as a master node (MN).

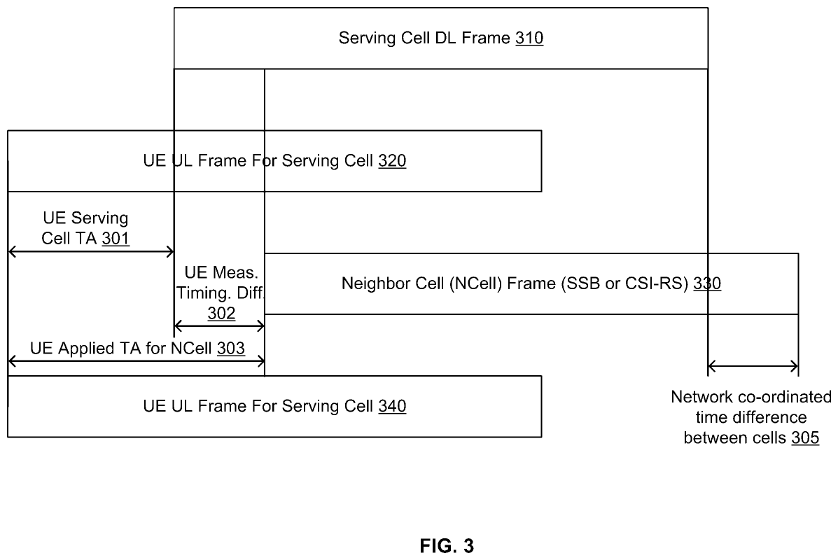

FIG. 3 illustrates an example of a UE-based TA estimation, in accordance with some embodiments. The UE-based TA estimation can also be referred to as a UE-based TA acquisition or, more generally, a TA estimation or TA acquisition performed by a UE.

In the example illustration, the UE is connected to a serving cell. At a first time, the UE receives a downlink frame 310 of the serving cell. At a second time, the UE sends an uplink frame 320 to the serving cell. The second time is illustrated in FIG. 3 as preceding the first time by a first TA 310 corresponding to the communication between the UE and the serving cell.

The UE may also not be connected to a neighbor cell (although it is possible for the connection to also be already established). At a third time, the UE receives a downlink frame 330 of the neighbor cell. This downlink frame 330 can indicate a reference signal (e.g., SSB, CSI-RS, etc.), where such reference signal can be represented by one or more symbols of the downlink frame 330. The difference between the first time and the third time is shown in FIG. 3 as a UE measurement timing difference 302. In particular, the UE can perform a timing measurement on the reference signal to determine the third time (e.g., the start of the DL frame 330) to then derive the time difference 302 relative to the start of the downlink frame 310 (e.g., where the first time can also be derived from a reference signal indicated in the downlink frame 310).

To send an uplink frame to the neighbor cell (e.g., once the UE is in a CONNECTED mode with the neighbor cell), the UE can perform a UE-based time estimation of a second TA 302 to use for such an uplink frame. Here, the second TA 303 can be a function (e.g., a sum) of the first TA 301 and the timing difference 302.

In an example, the timing difference 302 measured by the UE can be equal (or substantially equal within an acceptable tolerance margin) to the network coordinated time difference between the cells.

To make sure that UE actual uplink timing is close enough to the ideal (or expected) uplink timing, tight synchronization is needed across cells. It can be assumed that the absolute value of uplink timing difference towards the serving cell and the target cell is same as the absolute value of downlink timing difference measured at UE.

For an unsynchronized network, the measured TA includes both synchronization error between two cells and propagation delay difference, which cannot be differentiated by UE. Therefore, the measured timing difference cannot be used for uplink timing determination towards the target cell.

Tight synchronization can be achieved by global navigation satellite system (GNSS), likely in time divisional duplex (TDD) systems. There need not be a requirement to inform the UE about how the network achieve the synchronization. The base stations can be aware of the synchronization and this awareness can be base station implementation specific.

Since the tight sync requirements are base stion implementation specific, techniques are needed to inform the UE about which set of cells are tight synchronized (so that the UE can be allowed to use the UE-based TA estimation). A signaling framework is also needed to trigger the timing measurements of the neighbor cell reference signal(s). Similarly, a signaling framework is needed for the network to inform the UE to perform TA based adjustment (e.g., in the context of an LTM switch where the UE switches from one LTM cell to another LTM cell). The signaling frameworks need to allow the UE to not perform the UE-based TA estimation, if the UE does not support this estimation. Similarly, the network needs to be capable of informing the UE to not perform the UE-based TA estimation (even when the UE is capable), if the target cell is not capable of handling a RACH-less LTM switch. Error correction of the TA after the UE has applied the TA based estimation needs to be also supported. These and other features of a UE-based TA estimation techniques are further described herein below.

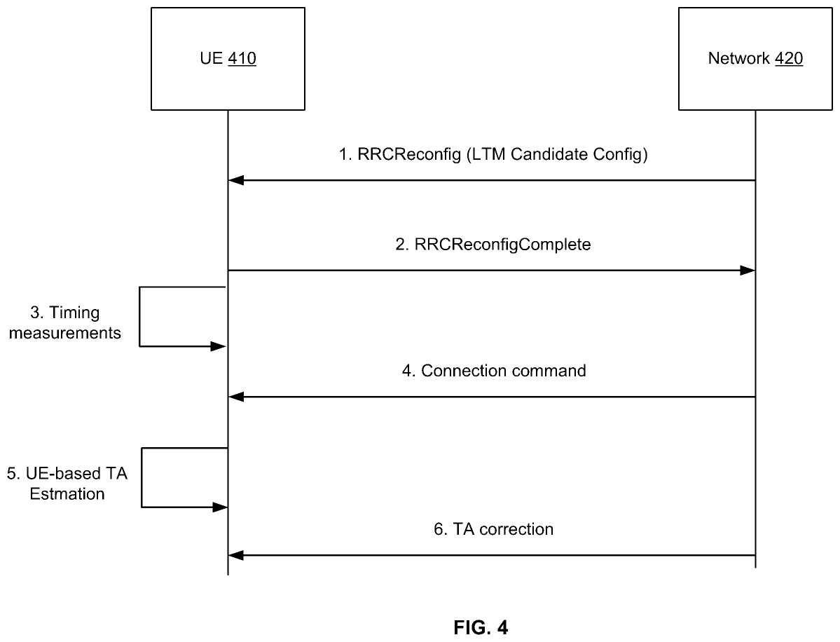

FIG. 4 illustrates an example of a procedure related to a UE-based TA estimation, in accordance with some embodiments. The procedure can be implemented by a UE 410 (an example of the UE 204) and a network 420 (any of the networks described herein) that includes base station CUs and DUs. Generally, the UE 410 receives from the network 420 (e.g., a gNB-CU thereof) configuration information for one or more sets of candidate cells for intra-DU mobility and/or for one or more sets of candidate cells for inter-DU mobility. The configuration information can be received via RRC signaling. Subsequently, the UE 410 can perform timing measurements on downlink signals across some or all of such candidate cells. Upon being instructed to establish one or more connections (e.g., via a MAC handover command), the UE can use one or more of the timing measurements to derive at least a TA for a new connection and can use the TA for uplink transmission over the connection.

In the example illustration, the UE 410 receives an RRCReconfiguration message from the network 420 (or multiple ones of such message from, for example, a gNB-CU). The received RRC reconfiguration information indicates, among other things, configurations of candidate cells including LTM candidate cells. A configuration for a candidate LTM cell can be referred to herein as an LTM candidate cell configuration. In addition, the received RRC reconfiguration information indicates configurations for sets of LTM cells (e.g., each set represents a group of cells having an LTM association that can allow the UE to perform a UE-based TA estimation). A configuration for a group of LTM cells can be referred to herein as an LTM group configuration. An LTM group configuration can be separate from an LTM cell configuration and, possibly, referenced in the LTM cell configuration. Additionally, or alternatively, the received RRC reconfiguration information indicates a configuration for one or more measurement objects. Such a configuration can be referred to herein as a measurement object configuration. The measurement object configuration can indicate whether a UE-based TA estimation is allowed or not. The UE 410 can respond to the network 420 (e.g., to the gNB-CU) with an RRCReconfigurationComplete message (or multiple ones of such message).

Next, the UE can determine that a set of criteria is met to trigger timing measurements. This set can relate to connection conditions, such as RSRPs and/or RSRQs of a serving cell falling below a threshold(s) and/or RSRPs and/or RSRQs of a detected neighbor cell exceeding a threshold(s)). Here, the UE can perform timing measurements on downlink reference signals (e.g., SSBs and/or CSI-RSs) of various cells. In an example, these cells can include the serving cells and neighbor cells. In this example, the timing measurements need not be performed for all neighbor cells. In particular, the timing measurements can be used to possibly and subsequently complete a UE-based TA estimation. As such, the timing measurements can be made for candidate cells, such as candidate LTM cells, that belong to the same LTM group as the serving cell. Timing measurements need not be performed for other detected neighbor cells.

The UE 410 can receive from the network 420 (e.g., from the gNB-CU or a gNB-DU of the serving cell in which the UE 410 is camped), a connection command (e.g., a MAC CE for a handover for an LTM switch). This command can indicate a target cell and, optionally, a trigger for a UE-based TA estimation as applicable. If not explicitly indicated in the connection command, the UE can determine whether the UE-based TA estimation is implicitly triggered. In particular, based on the source cell (e.g., the current serving cell) and the target cell, the UE 410 can determine from the LTM cell configuration information, the LTM group configuration information, and/or the measurement object configuration information whether an LTM association exists between these two cells and whether the UE-based TA estimation is to be used (e.g., in the case that the two cells belong to the same LTM group). If so, the UE uses the timing measurements of the two cells (e.g., as described in FIG. 3) determined prior to the connection command to estimate the TA to use for uplink frame transmission to the target cell. Otherwise, the UE can expect the network (e.g., via a RACH procedure) to provide the TA to use.

The UE 410 can then establish a connection with the target cell (e.g., with the relevant TRP) by performing a handover. Data can then be exchanged between the UE 410 and the target cell. Uplink data transmission from the UE can be timed according to the determined TA. The network 420 (e.g., the gNB-CU or DU) can detect from the uplink data (e.g., based on measurements on the uplink frames) that the TA is incorrect (e.g., its value can exceed a certain threshold). In this case, the network 420 can send a TA correction command. This command can be a random access response (RAR) MAC CE (even when no RACH procedure is performed) and/or a TA MAC CE.

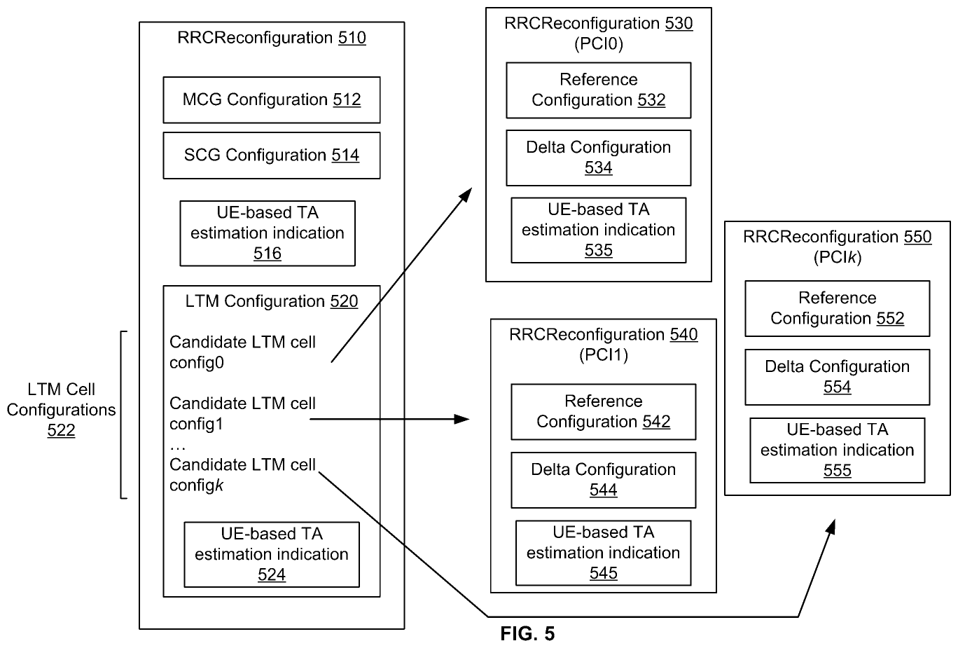

FIG. 5 illustrates an example of information indicated in a RRC configuration for a UE-based TA estimation, in accordance with some embodiments. The RRC configuration information can be received from a base station CU and can indicate, among other things, LTM cell configurations for candidate LTM cells, LTM group configurations, and/or measurement object configurations. Any or a combination of these configurations can indicate whether a UE-based TA estimation is allowed (or enabled) and/or parameters for using the UE-based estimation (e.g., the cell groups or candidate cells for which UE-based TA estimation is allowed).

In the example illustration of FIG. 5, the RRC configuration information indicates an RRCReconfiguration 510 that can be received from a gNB-CU of a base station (e.g., the gNB-CU 220). This RRCReconfiguration 510 includes, possibly, a master cell group (MCG) configuration 512 and a secondary cell group (SCG) configuration 514. Further, the RRCReconfiguration 510 includes a UE-based TA estimation indication 516. This indication 516 can correspond to or be included in, for example, a measurement object configuration for a measurement object and can be used by the UE to determine whether the UE-based TA estimation is allowed (or enabled) or disallowed (or disabled) for measurements associated with the measurement object.

In the illustration of FIG. 5, the RRCReconfiguration 510 also includes an LTM configuration 520. The LTM configuration 520 indicates the configuration of “k” candidate cells provided by the gNB-CU. Some of these candidate cells are provided by the same gNB-DU of the base station, whereas other candidate cells are provided by a different gNB-DU of the base station. These cells can be candidate LTM cells. Referring back to FIG. 2, the gNB-CU 220 is connected to gNB-DU 210 that in turn provides PCI0, PCI1, PCI3, PCI4, PCI5, and PCI6. As such “k” is six here (where PCI2 is not part of the provided cells). As such, the LTM configuration 520 indicates six LTM cell configurations 522, each of which corresponding to PCI0 (e.g., candidate LTM cell 230), PCI1 (e.g., candidate LTM cell 231), PCI3 (e.g., candidate LTM cell 233), PCI4 (e.g., candidate LTM cell 234), PCI5 (e.g., candidate LTM cell 235), and PCI6 (e.g., candidate LTM cell 236).

In addition, the LTM configuration 520 a UE-based TA estimation indication 524. In one example, the indication 524 is for a group of candidate LTM cells (e.g., one indication for the first set 240, and a second indication for the second set 250). This indication 524 can correspond to or be included in, for example, an LTM group configuration for the group and can be used by the UE to determine whether the UE-based TA estimation is allowed (or enabled) or disallowed (or disabled) for measurements associated with the candidate LTM cells that belong to the group.

As further illustrated in FIG. 5, each of the LTM cell configurations 522 can corresponds to a candidate LTM cell and include its own RRCReconfiguration. In turn, each of such RRCReconfigurations can include a UE-based TA estimation indication that informs the UE whether the UE-based TA estimation can be used in association with the corresponding candidate LTM cell. In the illustration of FIG. 5, the first one of the LTM cell configurations 522 corresponds to a first LTM cell (e.g., PCI0), the second one of the LTM cell configurations 522 corresponds to a second LTM cell (e.g., PCI1), and so on until the kth one of the LTM cell configurations 522 corresponding to a kth LTM cell (e.g., PCI6). The first LTM cell (e.g., PCI0) can have a first RRC configuration 530 that includes a reference configuration 532 (e.g., one command to candidate LTM cells), a delta configuration 534 (e.g., one specific to the candidate LTM cell), and a UE-based TA estimation indication 535. Similarly, the second LTM cell (e.g., PCI1) can have a second RRC configuration 540 that includes a reference configuration 542 (e.g., one command to candidate LTM cells), a delta configuration 544 (e.g., one specific to the candidate LTM cell), and a UE-based TA estimation indication 545. Additionally, or alternatively, the kth LTM cell (e.g., PCI6) can have a kth RRC configuration 550 that includes a reference configuration 552 (e.g., one command to candidate LTM cells), a delta configuration 554 (e.g., one specific to the candidate LTM cell), and a UE-based TA estimation indication 555. These and other configuration variations are further illustrated in the next figures.

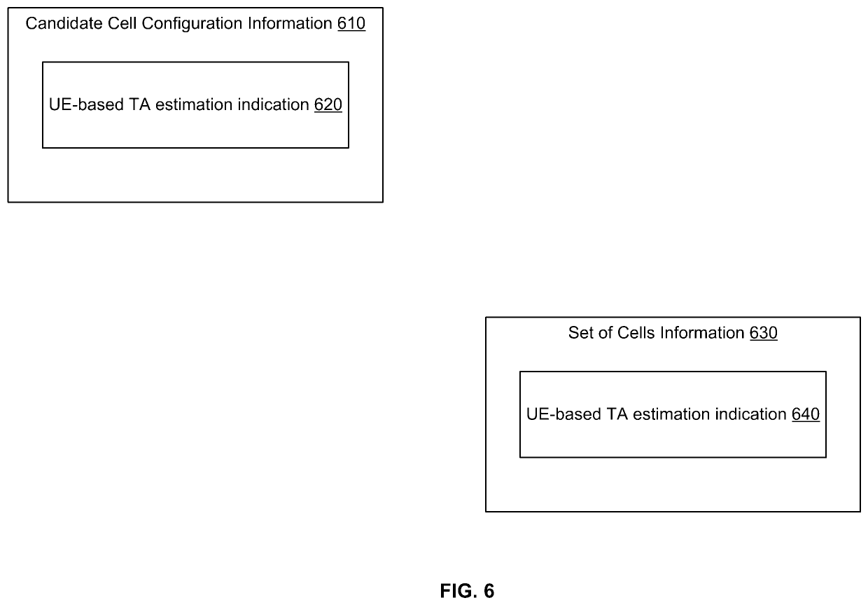

FIG. 6 illustrates examples of information indicated in a RRC configuration for a UE-based TA estimation, in accordance with some embodiments. The top left side of FIG. 6 illustrates a first example, whereas the bottom right side of FIG. 6 illustrates a second example. In both examples, a network provides, to a UE, the set of LTM cells that are to be considered by the UE as the candidates for the UE-based TA estimation. In both example, the information about the of cells (e.g., the first set 240 or the second set 250) is provided as part of RRC configuration.

In the first example, each candidate cell has its own candidate cell configuration information 610. The candidate cell configuration information 610 of a candidate cell includes a UE-based TA estimation indication 620 indicating whether this candidate cell is to be viewed as a potential candidate for a UE-based TA estimation. If so, upon detecting the candidate cell (e.g., by receiving reference signals therefrom but without being in a CONNECTED mode therewith), the UE can perform timing measurements on such reference signals and can use these timing measurements to derive the TA for the candidate cell upon receiving a command that triggers the use of the UE-based TA estimation. Otherwise, no timing measurements may be performed, and the UE can expect to receive a network-based TA for the candidate cell.

In the context of a 5G NR system, the following information can be defined in a technical specification to capture the above approach for the explicit group configuration.

RRCReconfiguration-v1800-IEs ::= SEQUENCE {

| | |
|---|---|
| ltmMobilityConfig | LTM-MobilityConfig-v18xy OPTIONAL, -- Need M |

```
}
LTM-MobilityConfig-v18xy ::= SEQUENCE {
  LTM-MobilityCanididatesToRemoveList-r18 LTMCandidatesToRemoveList-r18
OPTIONAL, -- Need N
  LTM-MobilityCanididatesToAddModList-r18 LTmCandidatesToAddModList-r18
OPTIONAL -- Need N
}
LTMCandidatesToAddModList-r18 ::= SEQUENCE {
  LTMCandidateConfigList SEQUENCE (SIZE(1..maxL2Candidates))
OF LTMCandidateConfig-r18 OPTIONAL, -- Need M
}
LTMCandidateConfig-r18 ::= SEQUENCE {
```

| | |
|---|---|
| candidateConfigID-r18 | INTEGER (1..maxLTMCandidates) OPTIONAL, |
| candidateLTMConfig-r18 | OCTET STRING (CONTAINING RRCReconfiguration- |

IEs) OPTIONAL,

| | |
|---|---|
| ueBasedTA-Allowed | ENUMERATED {allowed}, |

...
}

In the first example, each candidate cell also has its own candidate cell configuration information. Here, however, the UE is configured with an LTM group configuration (e.g., for the first set 240 or the second set 250). In particular, a set of cells information 630 is stored by the UE and corresponds to this group configuration. The set of cells information 630 includes a UE-based TA estimation indication 640 indicating whether each cell of the set is to be viewed as a potential candidate for a UE-based TA estimation. If so, upon detecting a candidate cell of the set (e.g., by receiving reference signals therefrom but without being in a CONNECTED mode therewith), the UE can perform timing measurements on such reference signals and can use these timing measurements to derive the TA for the candidate cell upon receiving a command that triggers the use of the UE-based TA estimation. Otherwise, no timing measurements may be performed, and the UE can expect to receive a network-based TA for the candidate cell. As such a set of candidate cells are considered as a whole for a UE-based TA estimation. Only when the UE is within these cells, the UE would be allowed to use this method. For example, when the UE is connected to a serving cell and receives reference signals of another cell, and when these two cells belong to the same set for which a UE-based TA estimation indication 640 indicates that a UE-based TA estimation is allowed, the UE can then perform timing measurements usable subsequently to determine the TA for the other cell.

In the context of a 5G NR system, the following information can be defined in a technical specification to capture the above approach for the explicit group configuration.

RRCReconfiguration-v1800-IEs ::= SEQUENCE {

| | |
|---|---|
| ltmMobilityConfig | LTM-MobilityConfig-v18xy OPTIONAL, -- Need M |
| ltmUE-TA-Set | LTM-UE-TA-Config-v18xy OPTIONAL, -- Need M |

```
}
LTM-MobilityConfig-v18xy ::= SEQUENCE {
  LTM-MobilityCanididatesToRemoveList-r18 LTMCandidatesToRemoveList-r18
OPTIONAL, -- Need N
  LTM-MobilityCanididatesToAddModList-r18 LTmCandidatesToAddModList-r18
OPTIONAL -- Need N
}
LTMCandidatesToAddModList-r18 ::= SEQUENCE {
  LTMCandidateConfigList SEQUENCE (SIZE(1..maxL2Candidates)
OF LTMCandidateConfig-r18 OPTIONAL, -- Need M
}
LTMCandidateConfig-r18 ::= SEQUENCE {
```

| | |
|---|---|
| candidateConfigID-r18 | INTEGER (1..maxLTMCandidates) OPTIONAL, |
| candidateLTMConfig-r18 | OCTET STRING (CONTAINING RRCReconfiguration- |

```
IEs) OPTIONAL,
  ...
}
LTM-UE-TA-Config-v18xy ::= SEQUENCE {
  LTM-UE-TA-ToRemoveList-r18 LTM-UE-TA-ToRemoveList-r18 OPTIONAL, -- Need
N
  LTM-UE-TA-ToAddModList-r18 LTM-UE-TA-ToAddModList-r18 OPTIONAL --
Need N
}
LTMC-UE-TA-ToAddModList-r18 ::= SEQUENCE {
  LTM-UE-TA-SetList SEQUENCE (SIZE(1..maxL2TASets)) OF LTM-UE-TA-ListInfo-
r18 OPTIONAL, -- Need M
}
LTM-UE-TA-ListInfo-r18 ::= SEQUENCE {
```

| | |
|---|---|
| ueTA-ListInfoID-r18 | INTEGER (1..maxLTMTASets) OPTIONAL, |
| ueTA-Set-Cells-r18 | SEQUENCE (SIZE(1..maxL2Candidates)) |

OF candidateConfigID-r18 OPTIONAL, -- Need M
...
}

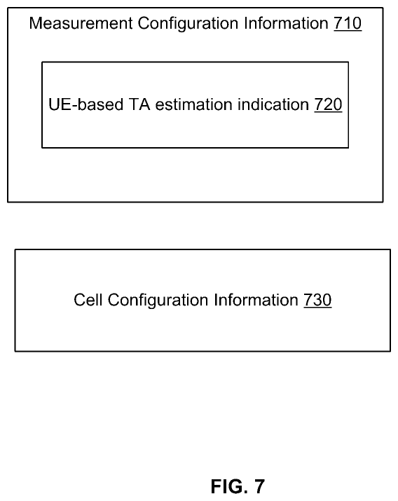

FIG. 7 illustrates another example of information indicated in a RRC configuration for a UE-based TA estimation, in accordance with some embodiments. Unlike the information described in FIG. 6, here the information relates to measurement objects. For instance, as part of the candidate cell configuration, a network does not provide any configuration about which LTM cells are to be considered for a UE-based TA estimation. Rather, as part of measurement configuration, the UE is configured with which target measurement cells are to be considered for the UE-based TA estimation.

This approach is illustrated in FIG. 7, whereby the UE stores measurement configuration information 710 and cell configuration information 730. The measurement configuration information 710 corresponds to one or more measurement configurations, whereas the cell configuration information 730 corresponds to one or more cell configurations. The measurement configuration(s) is (are) separate and excluded from the cell configuration(s) and vice versa. The measurement configuration information 710 includes a UE-based TA estimation indication 720 indicating whether a UE-based TA estimation is allowed (or enabled) or disallowed (or disabled) for a configured measurement (or a configured measurement set).

In an example, a measurement configuration for a measurement corresponds to the measurement configuration information 710 and can be sent as part of the serving cell that is configuring this measurement. In the context of a 5G NR system, the following information can be defined in a technical specification to capture the above approach for the explicit group configuration.

RRCReconfiguration-v1800-IEs ::= SEQUENCE {

| | |
|---|---|
| ltmMobilityConfig | LTM-MobilityConfig-v18xy OPTIONAL, -- Need M |

```
}
LTM-MobilityConfig-v18xy ::= SEQUENCE {
  LTM-MobilityCanididatesToRemoveList-r18 LTMCandidatesToRemoveList-r18
OPTIONAL, -- Need N
  LTM-MobilityCanididatesToAddModList-r18 LTMCandidatesToAddModList-r18
OPTIONAL -- Need N
}
LTM-MeasConfig-r18 ::= SEQUENCE {
```

| | |
|---|---|
| ltm-MeasObjectToRemoveList-r18 | LTM-MeasObjectToRemoveList-r18 OPTIONAL, |

-- Need N

| | |
|---|---|
| ltm-MmeasObjectToAddModList-r18 | LTM-MeasObjectToAddModList-r18 |

OPTIONAL, -- Need N

| | |
|---|---|
| ltm-ReportConfigToRemoveList-r18 | LTM-ReportConfigToRemoveList-r18 |

OPTIONAL, -- Need N

| | |
|---|---|
| ltm-ReportConfigToAddModList-r18 | LTM-RReportConfigToAddModList-r18 |

OPTIONAL, -- Need N

| | |
|---|---|
| ltm-MeasIdToRemoveList-r18 | LTM-MeasIdToRemoveList-r18 OPTIONAL, -- |

Need N

| | |
|---|---|
| ltm-MeasIdToAddModList-r18 | LTM-MeasIdToAddModList-r18 OPTIONAL, -- |

Need N
}
LTM-MeasObjectToAddMod ::= SEQUENCE {
ltm-MeasObjectId MeasObjectId,

| | |
|---|---|
| ssbFrequency | ARFCN-ValueNR OPTIONAL, |
| ueBasedTA-Allowed | ENUMERATED {allowed}, |

}
LTMCandidateConfig-r18 ::= SEQUENCE {

| | |
|---|---|
| candidateConfigID-r18 | INTEGER (1..maxLTMCandidates) OPTIONAL, |
| candidateLTMConfig-r18 | OCTET STRING (CONTAINING RRCReconfiguration- |

IEs) OPTIONAL,

| | |
|---|---|
| LTM-measConfig | LTM-MeasConfig-r18 OPTIONAL, -- Need N |

...
}

In another example, a measurement configuration for a measurement corresponds to the measurement configuration information 710 and can be sent as part of the candidate neighbor cell. In the context of a 5G NR system, the following information can be defined in a technical specification to capture the above approach for the explicit group configuration.

RRCReconfiguration-v1800-IEs ::= SEQUENCE {

| | |
|---|---|
| ltmMobilityConfig | LTM-MobilityConfig-v18xy OPTIONAL, -- Need M |

```
}
LTM-MobilityConfig-v18xy ::= SEQUENCE {
  LTM-MobilityCanididatesToRemoveList-r18 LTMCandidatesToRemoveList-r18
OPTIONAL, -- Need N
  LTM-MobilityCanididatesToAddModList-r18 LTMCandidatesToAddModList-r18
OPTIONAL -- Need N
```

| | |
|---|---|
| LTM-measConfig | LTM-MeasConfig-r18 OPTIONAL, -- Need N |

}
LTM-MeasConfig-r18 ::= SEQUENCE {

| | |
|---|---|
| ltm-MeasObjectToRemoveList-r18 | LTM-MeasObjectToRemoveList-r18 OPTIONAL, |

-- Need N

| | |
|---|---|
| ltm-MmeasObjectToAddModList-r18 | LTM-MeasObjectToAddModList-r18 |

OPTIONAL, -- Need N

| | |
|---|---|
| ltm-ReportConfigToRemoveList-r18 | LTM-ReportConfigToRemoveList-r18 |

OPTIONAL, -- Need N

| | |
|---|---|
| ltm-ReportConfigToAddModList-r18 | LTM-RReportConfigToAddModList-r18 |

OPTIONAL, -- Need N

| | |
|---|---|
| ltm-MeasIdToRemoveList-r18 | LTM-MeasIdToRemoveList-r18 OPTIONAL, -- |

Need N

| | |
|---|---|
| ltm-MeasIdToAddModList-r18 | LTM-MeasIdToAddModList-r18 OPTIONAL, -- |

Need N
}
LTM-MeasObjectToAddMod ::= SEQUENCE {
ltm-MeasObjectId MeasObjectId,

| | |
|---|---|
| ssbFrequency | ARFCN-ValueNR OPTIONAL, |
| ueBasedTA-Allowed | ENUMERATED {allowed}, |

}
LTMCandidateConfig-r18 ::= SEQUENCE {

| | |
|---|---|
| candidateConfigID-r18 | INTEGER (1..maxLTMCandidates) OPTIONAL, |
| candidateLTMConfig-r18 | OCTET STRING (CONTAINING RRCReconfiguration- |

IEs) OPTIONAL,
...
}

In yet another example, a measurement configuration for a measurement corresponds to the measurement configuration information 710 and can be independently configured of the LTM cells (e.g., including the serving cell and the candidate neighbor cell). In the context of a 5G NR system, the following information can be defined in a technical specification to capture the above approach for the explicit group configuration.

RRCReconfiguration-v1800-IEs ::= SEQUENCE {

| | |
|---|---|
| ltmMobilityConfig | LTM-MobilityConfig-v18xy OPTIONAL, -- Need M |
| LTM-measConfig | LTM-MeasConfig-r18 OPTIONAL, -- Need N |

```
}
LTM-MobilityConfig-v18xy ::= SEQUENCE {
  LTM-MobilityCanididatesToRemoveList-r18 LTMCandidatesToRemoveList-r18
OPTIONAL, -- Need N
  LTM-MobilityCanididatesToAddModList-r18 LTMCandidatesToAddModList-r18
OPTIONAL -- Need N
}
LTM-MeasConfig-r18 ::= SEQUENCE
```

| | |
|---|---|
| ltm-MeasObjectToRemoveList-r18 | LTM-MeasObjectToRemoveList-r18 OPTIONAL, |

-- Need N

| | |
|---|---|
| ltm-MmeasObjectToAddModList-r18 | LTM-MeasObjectToAddModList-r18 |

OPTIONAL, -- Need N

| | |
|---|---|
| ltm-ReportConfigToRemoveList-r18 | LTM-ReportConfigToRemoveList-r18 |

OPTIONAL, -- Need N

| | |
|---|---|
| ltm-ReportConfigToAddModList-r18 | LTM-RReportConfigToAddModList-r18 |

OPTIONAL, -- Need N

| | |
|---|---|
| ltm-MeasIdToRemoveList-r18 | LTM-MeasIdToRemoveList-r18 OPTIONAL, -- |

Need N

| | |
|---|---|
| ltm-MeasIdToAddModList-r18 | LTM-MeasIdToAddModList-r18 OPTIONAL, -- |

Need N
}
LTM-MeasObjectToAddMod ::= SEQUENCE {
ltm-MeasObjectId MeasObjectId,

| | |
|---|---|
| ssbFrequency | ARFCN-ValueNR OPTIONAL, |
| ueBasedTA-Allowed | ENUMERATED {allowed}, |

}
LTMCandidateConfig-r18 ::= SEQUENCE {

| | |
|---|---|
| candidateConfigID-r18 | INTEGER (1..maxLTMCandidates) OPTIONAL, |
| candidateLTMConfig-r18 | OCTET STRING (CONTAINING RRCReconfiguration- |

IEs) OPTIONAL,
...
}

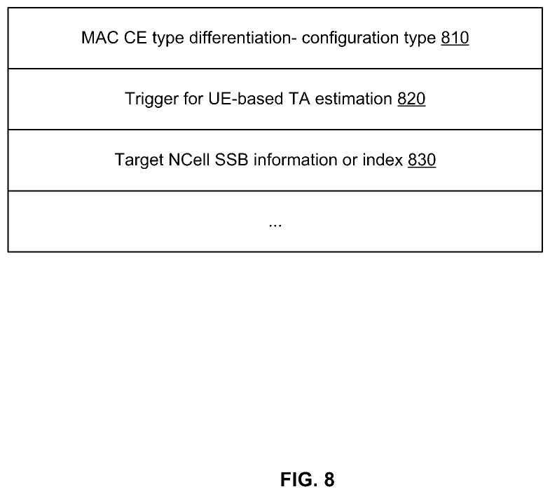

FIG. 8 illustrates an example of a command to trigger using timing measurements for computing a TA, in accordance with some embodiments. A UE may have been configured for a UE-based TA estimation as described herein above. Accordingly, the UE may perform timing measurements for candidate cells depending on the configuration. Subsequently, a network can send, to the UE, a command triggering the completion of the UE-based TA estimation. In particular, the command can indicate a target cell and the UE may use the related timing measurements to derive the TA to use for uplink transmissions to the target cell. The trigger can be explicit by indicating that the UE-based TA estimation is to be used. Alternatively, the trigger can be implicit, whereby the UE can determine based on the target cell and a source cell that the related configurations allows the UE-based TA estimation.

In an example, the command includes a MAC CE command. For instance, the measurement trigger (to use the time measurements in order to determine a timing difference 302 and compute a TA 303) can be from a MAC CE. This MAC CE can include the target cell for which the timing difference 302 is needed. This approach implies that there is no RRC specific configuration for a UE-based TA estimation. Rather, at runtime, the network, via the MAC CE, triggers the UE to measure timing difference 302.

In another illustration, the network can, as part of a MAC CE for an LTM switch, provide the trigger that the UE should measure the timing difference 302 of the target cell, and then derive the TA 303 based on timing difference 302 such that the UE applies TA 303 as part of the LTM switch. In this illustration, the network can control the UE-based TA estimation application, based on whether the target TRP/cell actually supports this feature or not (irrespective of whether the source and the target cells are tightly synchronized). Multiple approaches are possible for this illustration. In one approach, the UE performs the timing difference calculation and derives the TA 303 as part of the LTM switch command. In another approach, the network first sends a MAC CE (as in the above illustration) to trigger the UE to perform the timing difference calculation and derive the TA 303. However, the UE does not actually apply the TA 302 until receiving an LTM switch MAC CE from the network.

The two above illustrations are shown in FIG. 8 in connection with a MAC CE (e.g., a handover MAC CE as in the first illustration or an LTM MAC CE as in the second illustration). The MAC CE includes a MAC CE type differentiation 810 that indicates a configuration type (e.g., being usable for a UE-based TA estimation), a trigger 820 for the UE-based TA estimation (e.g., used in case of an explicit trigger, where the trigger 820 can indicate whether to derive and apply a TA, or derive but do not apply a TA, or apply a TA if previously derives), and a target neighbor cell SSB information or index 830 for the timing difference calculation (e.g., which may identify a target cell and a particular reference signal to use), among other information. Each of such types of information can be set according to particular its in the MAC CE.

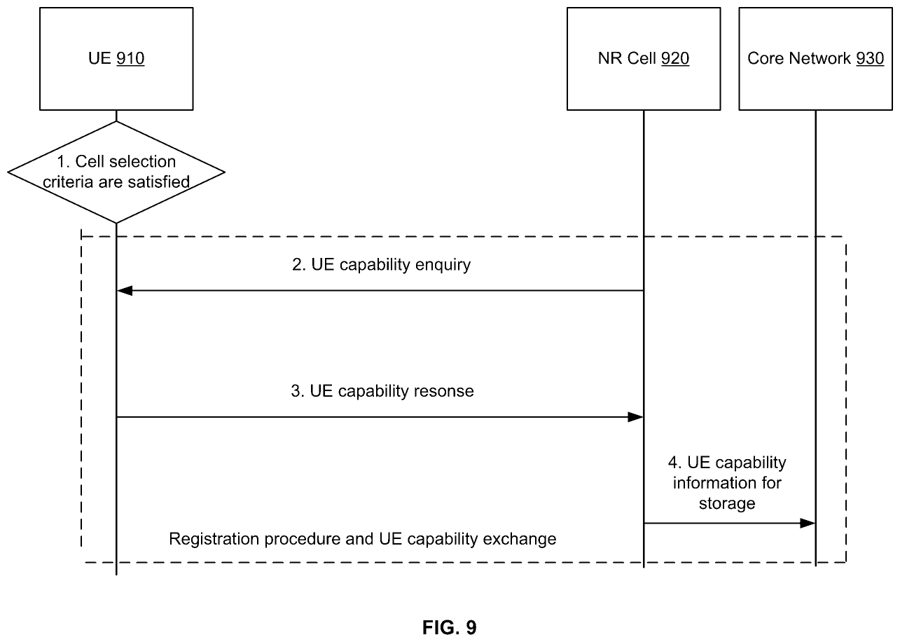

FIG. 9 illustrates an example of indicating a capability of a UE 910 for supporting a UE-based TA estimation, in accordance with some embodiments. In an example, the UE 910 sends capability information (e.g., via RRC signaling) to a network indicating whether the UE 910 does or does not support the UE-based TA estimation. Additionally, or alternatively, the capability information can be more granular, whereby the UE 910 can indicate its supports of a UE-based TA estimation in association with one or more parameters. These parameters can include the frequencies, bands of frequencies, combinations of bands, number of target cells, number of frequencies, number of bands, number of band combinations, and the like. The network can then configure the UE 910 based on the capability information and can subsequently trigger the UE-based TA estimation as applicable.

In the illustration of FIG. 9, the network includes an NR cell 920 and a core network 930. The UE 910 determines that cell selection criteria are satisfied to select the NR cell 920 such that a connection can be established therewith according to a registration procedure. Next, the registration procedure is performed. As part of this procedure, a UE capability exchange is performed. In particular, the NR cell 920 sends a UE capability enquiry to the UE 910 requesting the UE 910 to indicate its capability to support a UE-based TA estimation. The UE 910 then responds with capability response indicating its capability to support the UE-based TA estimation. The NR cell 920 can send the received UE capability information to the core network 930 for storage and subsequent use (e.g., by the NR cell 920 or other cells of the network 930).

In an example, the UE capability indicates whether the UE 910 is capable of performing a UE-based TA estimation based on measuring a target cell's downlink reference signal. In one approach, the UE capability is such that if the UE 910 reports the support of the UE-based TA estimation, the UE capability further indicates whether the UE 910 can measure/derive on any target frequency irrespective of whether the UE's 910 current serving frequency is the same or different from the target cell's frequency. In a further approach, the UE capability can be reported as an intra-frequency capability. In particular, when the UE reports the UE-based TA estimation, then the intra-frequency capability indicates the UE's 910 capability to derive the TA estimation for all the target neighbor cells that are in the same frequency as the serving cell. In another approach, the UE capability can be reported as a per-band capability. In particular, the UE capability can be reported per-band, where when the UE 910 reports the capability for a particular band, then the UE 910 has the capability to derive the TA estimation for all the target neighbor cells that are in the same band. In yet a further approach, the UE capability can be reported as a per-band combination capability. In this approach, when the UE 910 reports the capability for a band combination, then the UE 910 has the capability to derive the TA estimation for all the target neighbor cells that are part of the bands that the band combination. Additionally, or alternatively, the UE 910 can report the UE capability per-band and per-band combination. In particular, when the UE 910 reports the for a band combination, the UE 910 also reports a set of bands on which the UE 910 has the capability to derive the TA estimation for all the target neighbor cells as long as the UE 910 is operating in the band combination (e.g., the serving cell uses a band of the t band combination).

In an example, the UE 910 can report its capability with respect to how many potential targets cell reference signals the UE 910 can measure/maintain for a future LTM switch. In one approach, the UE 910 can report a UE capability informing the network about how many timing (e.g., a number) differences 302 that the UE 910 can measure to derive TA(s). This number can be the number (e.g., maximum number) of target cells, target frequencies, bands, and/or band combinations. Of course, any of the approaches in the last two examples can be used as part of the UE capability.

In an example, the UE 910 can report its capability to one or more duplexing technologies. For example, the capability information indicates a capability of the UE 910 to perform the UE-based TA estimation for any band operating in a frequency division duplex (FDD) duplex manner. Additionally, or alternatively, the capability information indicates a capability of the UE 910 to perform the UE-based TA estimation for any band in a time division duplex (TDD) duplex manner.

In an example, the UE 910 can report its capability to one or more frequency bands. For example, the capability information indicates a capability of the UE 910 to perform the UE-based TA estimation for any band operating in a FR1 range. Additionally, or alternatively, the capability information indicates a capability of the UE 910 to perform the UE-based TA estimation for any band in a FR2-1 range. Additionally, or alternatively, the capability information indicates a capability of the UE 910 to perform the UE-based TA estimation for any band in a FR2-2 range.

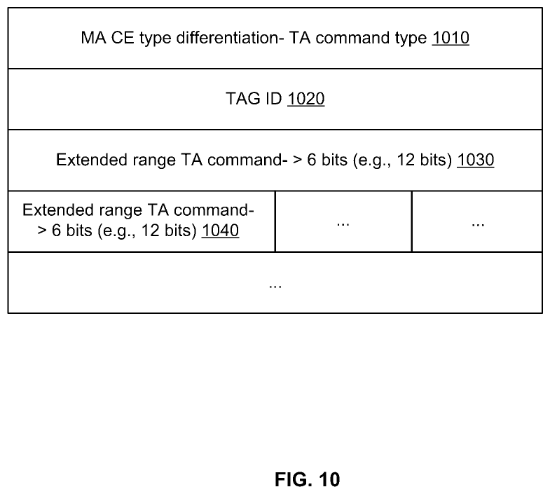

FIG. 10 illustrates an example of a command for correcting a UE-based TA estimation, in accordance with some embodiments. Generally, the UE can derive a TA for a cell as described herein above. The UE can then start sending data (e.g., uplink data) to the cell, where the timing of the data is set based on the TA. The network (e.g., the cell or a DU or CU) can determine that a TA correction is needed. For example, timing measurements can be performed on the uplink frames to determine that a timing offset exceeds an expected TA or a timing threshold. In another example, detecting the uplink data may fail or the error rate of such detection may exceed a threshold. The network can then send a TA correction to the UE.

In an example, the UE-based TA estimation does not rely on a RACH procedure. In other words, the UE does not send a RACH message to acquire the TA from the network (instead, the UE derives the TA). Because no RACH message, the UE need not expect or monitor a RAR response that indicates the TA. Nonetheless, upon detection of the need for a TA correction, the network can send a RAR response (e.g., a RAR MAC CE) that indicates the TA correction, and the UE can be configured to monitor and detect such a RAR response. In another example, the network sends a TA MAC CE that indicates the TA correction to the UE.

In an example, a MAC CE, such as a TA MAC CE, is used to indicate the TA correction. This MAC CE can have a wide range of correction, similar to a RAR MAC CE used in a typical RACH procedure, where this MAC CE is sent independently of a RACH procedure and includes more than six bits for the correction (e.g., providing a (0-3846) Tc range, by including twelve bits for the correction).

In an example, a RAR MAC CE is used, where this RAR MAC CE is sent independently of a RACH procedure. To enable this RACHless use of the RAR MAC CE, this CE can include a particular identifier (e.g., a cell radio network temporary identifier (C-RNTI)). The UE can be configured (e.g., by the network or pre-programmed) to parse RAR MAC CEs. Upon detecting a RAR MAC CE with the particular identifier (e.g., a match between an identifier in the RAR MAC CE and an identifier stored by the UE), the UE can apply the TA adjustment indicated by this RAM MAC CE.

The two above examples are shown in FIG. 10 in connection with a MAC CE (e.g., a TA MAC CE having the wide range of a RAR MAC CE or a RAR MAC CE used independently of a RACH procedure). The MAC CE includes a MAC CE type differentiation 1010 that indicates a TA command type (e.g., being usable for a TA correction), a timing advance group (TAG) identifier (ID) 1020 (e.g., indicating a TA group to which the TA correction command applies), an extended range timing advance command 1030 (e.g., bit field longer than six bits, such as a twelve bit field providing a wide correction range such as a (0-3846) Tc range in the case of twelve bits). Extended range timing advance commands 1040 can be repeated. In addition, the MAC CE can include a C-RNTI (not shown).

In an example, a UE performs a UE-based estimation and estimate a TA (e.g., based on a timing difference 302) and determines that the TA to apply is beyond the capability of the UE. For example, an amount of time may be needed for the UE to refine its transmit radio frequency chain for its connection with a target cell. The TA may not support this amount of time (e.g., by being smaller). In this case, the UE can follow a procedure of a radio link failure recover for LTM.

For instance, the UE can declare a radio link failure event. Upon this even, the UE can search for a suitable candidate cell. If the candidate cell satisfies cell selection criteria and the candidate cell is an LTM cell, the UE can generate message includes a UE identity (e.g., C-RNTI, a current PCI, ShortMac-1, etc.) and a new cause for the failure (e.g., LTM reconfiguration failure, radio link failure, etc.). The UE can further wait for a response and proceed as instructed by the response. In some instances, the UE can initiate a timer and respond in accordance with whether a response message is received prior to expiration of the timer or if no message is received upon expiration of the timer.

In the radio link failure procedure, it is assumed that the UE and the selected candidate cell are both configured for LTM. In some embodiments, the UE is configured for LTM, however, the selected candidate cell is not configured for LTM. In this instance, the UE can resort to a legacy operation of RRC connection reestablishment to establish a connection with the selected candidate cell. Examples of the radio link failure procedure are described in WO Patent Application No. PCT/CN2023/075637, “RADIO LINK FAILURE AND HANDOVER FAILURE IN LAYER 1/LAYER 2 MOBILITY,” filed on Feb. 13, 2023, the content of which is incorporated herein by reference in its entirety.

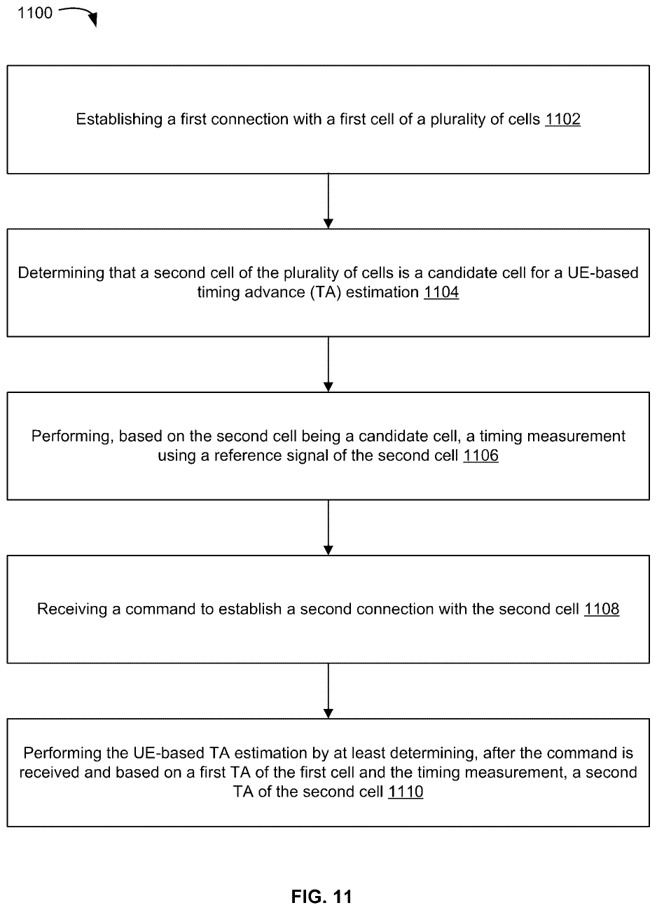

FIG. 11 illustrates an example of an operational flow/algorithmic structure implemented by a UE to perform a UE-based TA estimation, in accordance with some embodiments. The UE is an example of any of the UEs described in the present disclosure.

The operational flow/algorithmic structure 1100 may include, at 1102, establishing a first connection with a first cell of a plurality of cells. For example, the first cell is serving cell provided by a base station DU. This connection can be established using an RRC establishment procedure, an RRC reconnection procedure, or a handover procedure.

The operational flow/algorithmic structure 1100 may include, at 1104, determining that a second cell of the plurality of cells is a candidate cell for a UE-based timing advance (TA) estimation. For example, the second cell is a neighbor cell provided by the same base station DU, a different base station DU, or a base station CU. The determination can be based on RRC configuration information that includes a UE-based TA estimation indication. This indication can be part of the cell configuration of the second cell, of group configuration of a group of cells that includes at least the second cell, and/or a measurement configuration.

The operational flow/algorithmic structure 1100 may include, at 1106, performing, based on the second cell being a candidate cell, a timing measurement using a reference signal of the second cell. For example, based on cell selection criteria, the UE detects the second cell (e.g., by being a neighbor cell of the serving cell) but has not established a connection therewith (e.g., by being in a CONNECTED mode therewith). The reference signal can be an SSB or a CSI-RS sent in a downlink frame of the second cell.

The operational flow/algorithmic structure 1100 may include, at 1108, receiving a command to establish a second connection with the second cell. For example, the command can include a MAC CE handover command and/or a MAC CE LTM switch. The command can indicate the second cell and can explicitly or implicitly trigger the calculation of a timing difference based on the time measurement (and a similar time measurement on a reference signal of the first cell) and the computation of, based on a first TA of the first cell and the timing difference, a second TA for use in association with uplink transmissions to the second cell. The command can trigger any or a combination of the calculation of the timing difference, the calculation of the TA, or the application of the TA for the uplink transmissions.

The operational flow/algorithmic structure 1100 may include, at 1110, performing the UE-based TA estimation by at least determining, after the command is received and based on a first TA of the first cell and the timing measurement, a second TA of the second cell. For example, the second TA is computed as described in FIG. 3 after the command is received. The UE can also establish a second connection with the second cell in response to the command (e.g., by using a handover procedure) and can use the second TA for the uplink transmissions over this connection.

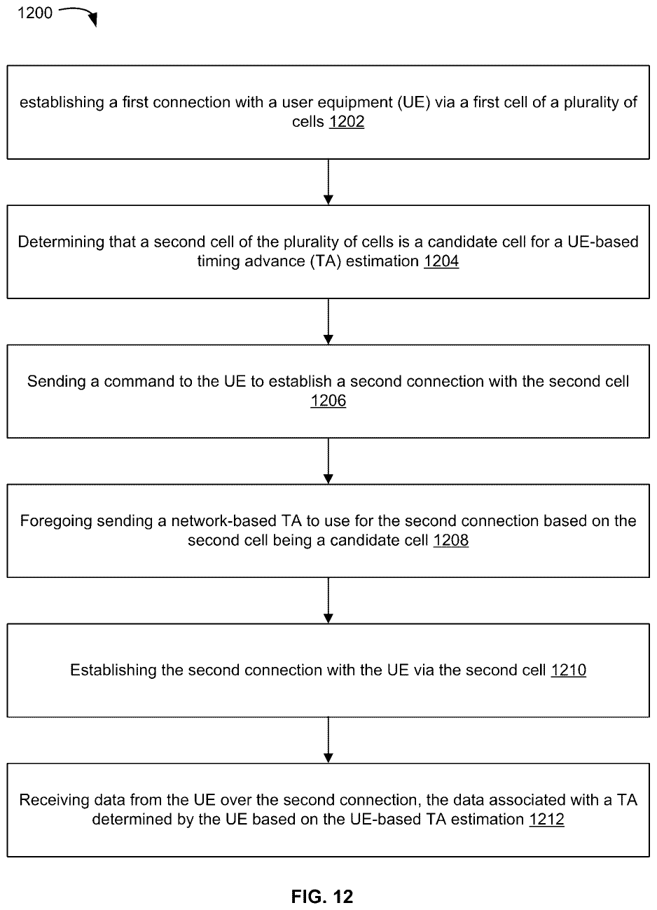

FIG. 12 illustrates an example of an operational flow/algorithmic structure implemented by a network to trigger a UE-based TA estimation, in accordance with some embodiments. The network is an example of any of the networks described in the present disclosure.

The operational flow/algorithmic structure 1200 may include, at 1202, establishing a first connection with a user equipment (UE) via a first cell of a plurality of cells. For example, the first cell is serving cell provided by a base station DU. This connection can be established using an RRC establishment procedure, an RRC reconnection procedure, or a handover procedure.

The operational flow/algorithmic structure 1200 may include, at 1204, determining that a second cell of the plurality of cells is a candidate cell for a UE-based timing advance (TA) estimation. For example, the UE may have sent capability information to the network, where this capability information indicates the UE's support for the UE-based TA estimation. The network can also determine that the second cell is tightly synchronized with the first cell such that the UE-based TA estimation can be allowed for the second cell upon a handover from the first cell.

The operational flow/algorithmic structure 1200 may include, at 1206, sending a command to the UE to establish a second connection with the second cell. For example, the command can include a MAC CE handover command and/or a MAC CE LTM switch. The command can indicate the second cell and can explicitly or implicitly trigger the calculation of a timing difference based on the time measurement (and a similar time measurement on a reference signal of the first cell) and the computation of, based on a first TA of the first cell and the timing difference, a second TA for use in association with uplink transmissions to the second cell. The command can trigger any or a combination of the calculation of the timing difference, the calculation of the TA, or the application of the TA for the uplink transmissions.

The operational flow/algorithmic structure 1200 may include, at 1208, foregoing sending a network-based TA to use for the second connection based on the second cell being a candidate cell. For example, because the UE supports the UE-based TA estimation and the second cell is a candidate cell, the network can determine that there is no need to send a TA to the UE. Instead, the network can assume that the UE can derive a TA to use for the UE's uplink transmission to the second cell.

The operational flow/algorithmic structure 1200 may include, at 1210, establishing the second connection with the UE via the second cell. For example, this connection is established in response to the command (e.g., by using a handover procedure).

The operational flow/algorithmic structure 1200 may include, at 1212, receiving data from the UE over the second connection, the data associated with a TA determined by the UE based on the UE-based TA estimation. For example, the data is received in an uplink frame sent by the UE over the second connection. The timing of the uplink frame can depend on the TA determined by the UE. As needed, the network can subsequently send a command to the UE for correcting this TA.

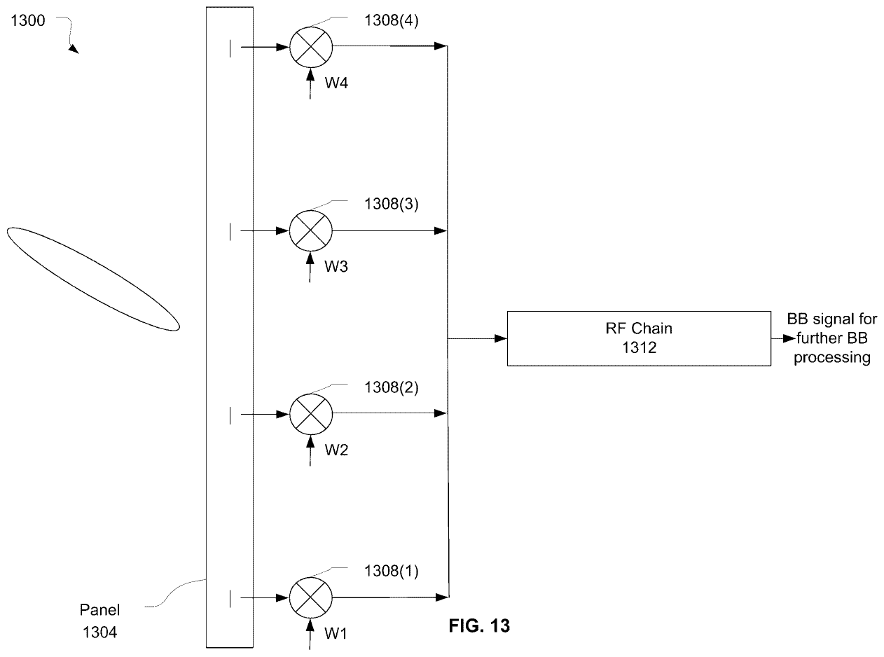

FIG. 13 illustrates receive components 1300 of, for example, a UE or a base station, in accordance with some embodiments. The receive components 1300 may include an antenna panel 1304 that includes a number of antenna elements. The panel 1304 is shown with four antenna elements, but other embodiments may include other numbers.

The antenna panel 1304 may be coupled to analog beamforming (BF) components that include a number of phase shifters 1308(1)-1308(4). The phase shifters 1308(1)-1308(4) may be coupled with a radio-frequency (RF) chain 1312. The RF chain 1312 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (for example W1-W4), which may represent phase shift values, to the phase shifters 1308(1)-1308(4) to provide a receive beam at the antenna panel 1304. These BF weights may be determined based on the channel-based beamforming.

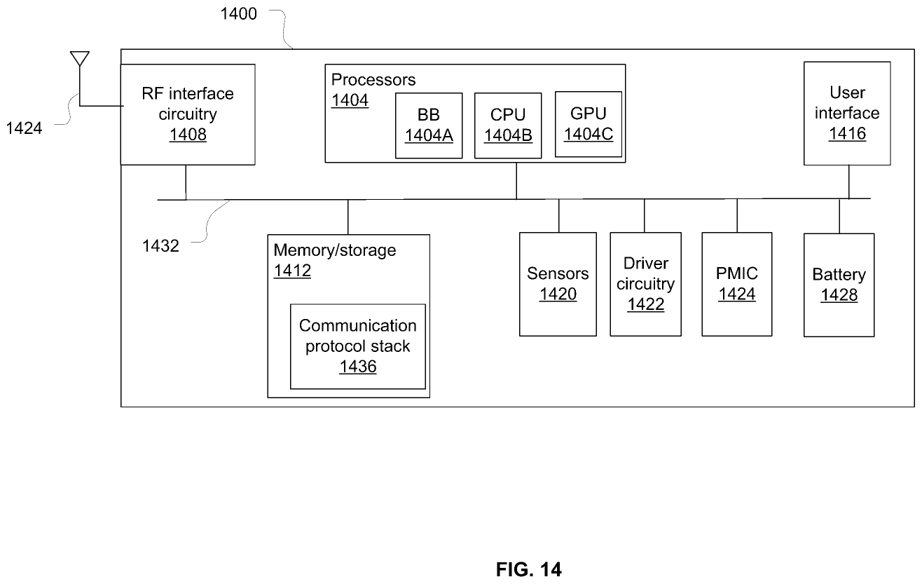

FIG. 14 illustrates a UE 1400, in accordance with some embodiments. The UE 1400 may be similar to and substantially interchangeable with any of the UEs described herein above.

Similar to that described above with respect to UE 144, the UE 1400 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1400 may include processors 1404, RF interface circuitry 1408, memory/storage 1412, user interface 1416, sensors 1420, driver circuitry 1422, power management integrated circuit (PMIC) 1424, and battery 1428. The components of the UE 1400 may be implemented as integrated circuits (ICs), portions thereof, discrete electronic devices, or other modules, logic, hardware, software, firmware, or a combination thereof. The block diagram of FIG. 14 is intended to show a high-level view of some of the components of the UE 1400. However, some of the components shown may be omitted, additional components may be present, and different arrangements of the components shown may occur in other implementations.

The components of the UE 1400 may be coupled with various other components over one or more interconnects 1432, which may represent any type of interface, input/output, bus (local, system, or expansion), transmission line, trace, optical connection, etc. that allows various circuit components (on common or different chips or chipsets) to interact with one another.

The processors 1404 may include processor circuitry, such as baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage 1412 to cause the UE 1400 to perform operations as described herein.

In some embodiments, the baseband processor circuitry 1404A may access a communication protocol stack 1436 in the memory/storage 1412 to communicate over a 3GPP compatible network. In general, the baseband processor circuitry 1404A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1408.

The baseband processor circuitry 1404A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 1404A may also access group information from memory/storage 1412 to determine search space groups in which a number of repetitions of a PDCCH may be transmitted.

The memory/storage 1412 may include any type of volatile or non-volatile memory that may be distributed throughout the UE 1400. In some embodiments, some of the memory/storage 1412 may be located on the processors 1404 themselves (for example, L1 and L2 cache), while other memory/storage 1412 is external to the processors 1404 but accessible thereto via a memory interface. The memory/storage 1412 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 1408 may include transceiver circuitry and a radio frequency front module (RFEM) that allows the UE 1400 to communicate with other devices over a radio access network. The RF interface circuitry 1408 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1450 and proceed to filter and amplify (with a low-noise amplifier) the signal. The signal may be provided to a receiver of the transceiver that down-converts the RF signal into a baseband signal that is provided to the baseband processor of the processors 1404.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1450.

In various embodiments, the RF interface circuitry 1408 may be configured to transmit/receive signals in a manner compatible with NR access technologies.

The antenna 1450 may include a number of antenna elements that each convert electrical signals into radio waves to travel through the air and to convert received radio waves into electrical signals. The antenna elements may be arranged into one or more antenna panels. The antenna 1450 may have antenna panels that are omnidirectional, directional, or a combination thereof to enable beamforming and multiple input, multiple output communications. The antenna 1450 may include microstrip antennas, printed antennas fabricated on the surface of one or more printed circuit boards, patch antennas, phased array antennas, etc. The antenna 1450 may have one or more panels designed for specific frequency bands including bands in FR1 or FR2.

The user interface circuitry 1416 includes various input/output (I/O) devices designed to enable user interaction with the UE 1400. The user interface 1416 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 1400.

The sensors 1420 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1422 may include software and hardware elements that operate to control particular devices that are embedded in the UE 1400, attached to the UE 1400, or otherwise communicatively coupled with the UE 1400. The driver circuitry 1422 may include individual drivers allowing other components to interact with or control various input/output (I/O) devices that may be present within, or connected to, the UE 1400. For example, driver circuitry 1422 may include a display driver to control and allow access to a display device, a touchscreen driver to control and allow access to a touchscreen interface, sensor drivers to obtain sensor readings of sensor circuitry 1420 and control and allow access to sensor circuitry 1420, drivers to obtain actuator positions of electro-mechanic components or control and allow access to the electro-mechanic components, a camera driver to control and allow access to an embedded image capture device, audio drivers to control and allow access to one or more audio devices.

The PMIC 1424 may manage power provided to various components of the UE 1400. In particular, with respect to the processors 1404, the PMIC 1424 may control power-source selection, voltage scaling, battery charging, or DC-to-DC conversion.

In some embodiments, the PMIC 1424 may control, or otherwise be part of, various power saving mechanisms of the UE 1400. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 1400 may power down for brief intervals of time and thus save power. If there is no data traffic activity for an extended period of time, then the UE 1400 may transition off to an RRC_Idle state, where it disconnects from the network and does not perform operations, such as channel quality feedback, handover, etc. The UE 1400 goes into a very low power state and it performs paging where again it periodically wakes up to listen to the network and then powers down again. The UE 1400 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1428 may power the UE 1400, although in some examples the UE 1400 may be mounted deployed in a fixed location and may have a power supply coupled to an electrical grid. The battery 1428 may be a lithium-ion battery, a metal-air battery, such as a zinc-air battery, an aluminum-air battery, a lithium-air battery, and the like. In some implementations, such as in vehicle-based applications, the battery 1428 may be a typical lead-acid automotive battery.

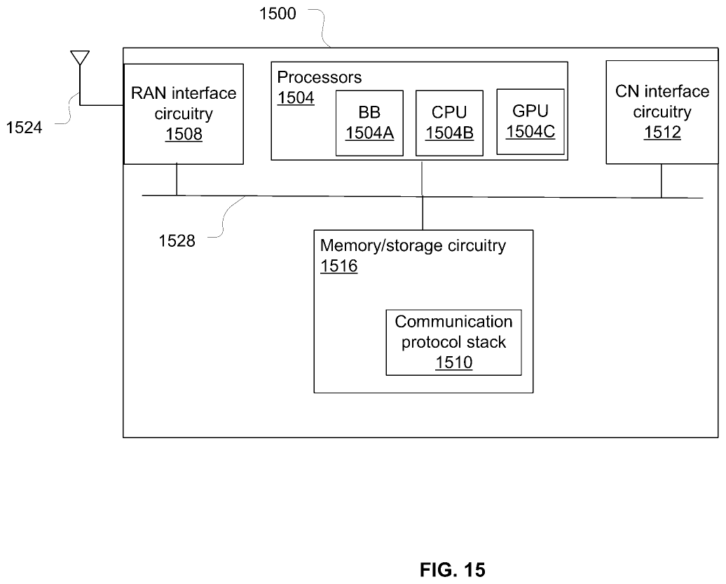

FIG. 15 illustrates a gNB 1500, in accordance with some embodiments. The gNB 1500 may be similar to and substantially interchangeable with any of the base stations described herein above.

The gNB 1500 may include processors 1504, RAN interface circuitry 1508, core network (CN) interface circuitry 1512, and memory/storage circuitry 1516.

The components of the gNB 1500 may be coupled with various other components over one or more interconnects 1528.

The processors 1504, RAN interface circuitry 1508, memory/storage circuitry 1516 (including communication protocol stack 1510), antenna 1550, and interconnects 1528 may be similar to like-named elements shown and described with respect to FIG. 14.

The CN interface circuitry 1512 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 1500 via a fiber optic or wireless backhaul. The CN interface circuitry 1512 may include one or more dedicated processors or FPGAs to communicate using one or more of the aforementioned protocols. In some implementations, the CN interface circuitry 1512 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further exemplary embodiments are provided.

Example 1 includes a method implemented by a user equipment (UE), the method comprising: establishing a first connection with a first cell of a plurality of cells; determining that a second cell of the plurality of cells is a candidate cell for a UE-based timing advance (TA) estimation; performing, based on the second cell being a candidate cell, a timing measurement using a reference signal of the second cell; receiving a command to establish a second connection with the second cell; and performing the UE-based TA estimation by at least determining, after the command is received and based on a first TA of the first cell and the timing measurement, a second TA of the second cell.

Example 2 includes the method of example 1, wherein the timing measurement is performed prior to the command being received.

Example 3 includes the method of any examples 1-2 further comprising: receiving a radio resource control (RRC) configuration indicating a set of cells of the plurality of cells to be considered as candidate cells for the UE-based TA estimation, wherein the set includes the second cell.

Example 4 includes the method of any examples 1-3 further comprising: receiving a radio resource control (RRC) configuration indicating a cell configuration for the second cell, wherein the cell configuration indicates that the UE-based TA estimation is allowed for the second cell.

Example 5 includes the method of example 4, wherein the RRC configuration indicates another cell configuration for a third cell of the plurality of cells, wherein the other cell configuration indicates that the UE-based TA estimation is disallowed for the third cell.

Example 6 includes the method of any examples 1-5 further comprising: receiving a radio resource control (RRC) configuration indicating a set of cells of the plurality of cells and that the UE-based TA estimation is allowed for the set; and determining that the second cell belongs to the set of cells.

Example 7 includes the method of any examples 1-6 further comprising: receiving a cell configuration and a measurement configuration, wherein the cell configuration indicates a configuration of the second cell, and wherein the measurement configuration is separate from the cell configuration and indicates that the UE-based TA estimation is allowed for the second cell.

Example 8 includes the method of example 7, wherein the cell configuration is received from the first cell.

Example 9 includes the method of example 7, wherein the cell configuration is received radio resource control (RRC) independent of the first cell and the second cell.

Example 10 includes the method of any examples 1-9, wherein the command includes a medium access control (MAC) control element (CE) associated with a handover to the second cell, wherein the MAC CE indicates the second cell and a trigger for the UE-based TA estimation.

Example 11 includes the method of any examples 1-10, wherein the command includes a layer 1/layer 2 triggered mobility (LTM) switch indicating the second cell and a trigger for the UE-based TA estimation.

Example 12 includes the method of any examples 1-11, wherein the command includes a medium access control (MAC) control element (CE) associated with a handover to the second cell and a layer 1/layer 2 triggered mobility (LTM) switch, wherein the MAC CE indicates a trigger for the UE-based TA estimation, and wherein the LTM switch indicates that the second TA is to be used for communications over the second connection.

Example 13 includes the method of any examples 1-12 further comprising: sending, to a network, capability information indicating that the UE is capable to perform the UE-based TA estimation based on a measurement of a target cell's reference signal.

Example 14 includes the method of example 13, wherein the command is received from the network based on the capability information and indicates a trigger to perform the UE-based TA estimation.

Example 15 includes the method of example 13, wherein the capability information indicates that the UE is capable to perform the measurement and derive a timing difference between two cells independently of whether the two cells use the same frequency.

Example 16 includes the method of any examples 14-15, wherein the capability information indicates an intra-frequency capability of the UE to perform the UE-based TA estimation for all target cells using the same frequency as a serving cell.

Example 17 includes the method of any examples 14-16, wherein the capability information indicates an intra-band capability of the UE to perform the UE-based TA estimation for all target cells using the same band as a serving cell.

Example 18 includes the method of any examples 14-17, wherein the capability information indicates a capability of the UE to perform the UE-based TA estimation for any band operating in a frequency division duplex (FDD) duplex manner or in a time division duplex (TDD) duplex manner.

Example 19 includes the method of any examples 14-18, wherein the capability information indicates a capability of the UE to perform the UE-based TA estimation for any band operating in a FR1 range, any band in a FR2-1 range, or any band in a FR2-2 range.

Example 20 includes the method of any examples 14-19, wherein the capability information indicates a band combination capability of the UE to perform the UE-based TA estimation for a combination of bands.

Example 21 includes the method of any examples 14-20, wherein the capability information indicates a per-band combination capability of the UE to perform the UE-based TA estimation for all target cells using a band combination as a serving cell.

Example 22 includes the method of any examples 14-21, wherein the capability information indicates a maximum number of cells for which the UE can perform reference signal measurements.

Example 23 includes the method of any examples 14-22, wherein the capability information indicates a maximum number of frequencies for which the UE can perform reference signal measurements.

Example 24 includes the method of any examples 1-23 further comprising: receiving a medium access control (MAC) control element (CE) that uses more than six bits to indicate a TA correction; and updating the second TA based on the TA correction.

Example 25 includes the method of any examples 1-24 further comprising: receiving a random access response (RAR) medium access control (MAC) control element (CE) that indicates a TA correction, wherein the RAR MAC CE is received independently of a random access channel (RACH) procedure; and updating the second TA based on the TA correction.

Example 26 includes the method of any examples 1-25 further comprising: determining that the second TA is beyond a capability of the UE; and initiating a link recovery facility for layer 1/layer 2 triggered mobility (LTM).

Example 27 includes a method implemented by a network, the method comprising: establishing a first connection with a user equipment (UE) via a first cell of a plurality of cells; determining that a second cell of the plurality of cells is a candidate cell for a UE-based timing advance (TA) estimation; sending a command to the UE to establish a second connection with the second cell; foregoing sending a network-based TA to use for the second connection based on the second cell being a candidate cell; establishing the second connection with the UE via the second cell; and receiving data from the UE over the second connection, the data associated with a TA determined by the UE based on the UE-based TA estimation.

Example 28 includes the method of example 27 further comprising: sending, to the UE, a radio resource control (RRC) configuration indicating a set of cells of the plurality of cells to be considered as candidate cells for the UE-based TA estimation, wherein the set includes the second cell.

Example 29 includes the method of any examples 27-28 further comprising: sending, to the UE, a radio resource control (RRC) configuration indicating a cell configuration for the second cell, wherein the cell configuration indicates that the UE-based TA estimation is allowed for the second cell.

Example 30 includes the method of any examples 27-29 further comprising: sending, to the UE, a radio resource control (RRC) configuration indicating a set of cells of the plurality of cells and that the UE-based TA estimation is allowed for the set, wherein the second cell belongs to the set of cells.

Example 31 includes the method of any examples 27-30 further comprising: sending, to the UE, a cell configuration and a measurement configuration, wherein the cell configuration indicates a configuration of the second cell, and wherein the measurement configuration is separate from the cell configuration and indicates that the UE-based TA estimation is allowed for the second cell.

Example 32 includes the method of any examples 27-31 further comprising: generating the command based on the determining that the second cell is a candidate cell, wherein the command includes a medium access control (MAC) control element (CE) associated with a handover to the second cell, and wherein the MAC CE indicates the second cell and a trigger for the UE-based TA estimation.

Example 33 includes the method of any examples 27-32 wherein the command includes either: first a layer 1/layer 2 triggered mobility (LTM) switch indicating the second cell and a first trigger for the UE-based TA estimation, or a medium access control (MAC) control element (CE) associated with a handover to the second cell and a second LTM switch, wherein the MAC CE indicates a second trigger for the UE-based TA estimation, and wherein the second LTM switch indicates that the TA is to be used for communications over the second connection.

Example 34 includes the method of any examples 27-33 further comprising: receiving, from the UE, capability information indicating that the UE is capable to perform the UE-based TA estimation based on a measurement of a target cell's reference signal wherein the command is sent based on the capability information and indicates a trigger to perform the UE-based TA estimation.

Example 35 includes the method of any examples 27-34 further comprising: sending, to the UE, a medium access control (MAC) control element (CE) that uses more than six bits to indicate a TA correction.

Example 36 includes the method of any examples 27-35 further comprising: sending, to the UE, a random access response (RAR) medium access control (MAC) control element (CE) that indicates a TA correction, wherein the RAR MAC CE is sent independently of a random access channel (RACH) procedure.

Example 37 includes a device comprising means to perform one or more elements of a method described in or related to any of the examples 1-36.

Example 38 includes one or more non-transitory computer-readable media comprising instructions to cause a device, upon execution of the instructions by one or more processors of the device, to perform one or more elements of a method described in or related to any of the examples 1-36.

Example 39 includes a device comprising logic, modules, or circuitry to perform one or more elements of a method described in or related to any of the examples 1-36.

Example 40 includes a device comprising: one or more processors and one or more computer-readable media comprising instructions that, when executed by the one or more processors, cause the one or more processors to perform one or more elements of a method described in or related to any of the examples 1-36.

Example 41 includes a system comprising means to perform one or more elements of a method described in or related to any of the examples 1-36.

Example 42 includes a network comprising means to perform one or more elements of a method described in or related to any of the examples 1-36.

Example 43 includes one or more non-transitory computer-readable media comprising instructions to cause a network, upon execution of the instructions by one or more processors of the network, to perform one or more elements of a method described in or related to any of the examples 1-36.

Example 44 includes a network comprising logic, modules, or circuitry to perform one or more elements of a method described in or related to any of the examples 1-36.

Example 45 includes a network comprising: one or more processors and one or more computer-readable media comprising instructions that, when executed by the one or more processors, cause the one or more processors to perform one or more elements of a method described in or related to any of the examples 1-36. [0199] Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

1-37. (canceled)

38. A method comprising:
determining, while a first connection with a first cell of a plurality of cells is established, that a second cell of the plurality of cells is a candidate cell for a user equipment (UE)-based timing advance (TA) estimation;
performing, based on the second cell being a candidate cell, a timing measurement using a reference signal of the second cell;
processing a command to establish a second connection with the second cell; and
performing the UE-based TA estimation by at least determining, after the command is received and based on a first TA of the first cell and the timing measurement, a second TA of the second cell.

39. The method of claim 38, wherein the timing measurement is performed prior to the command being received.

40. The method of claim 38 further comprising:
processing a radio resource control (RRC) configuration indicating a set of cells of the plurality of cells to be considered as candidate cells for the UE-based TA estimation, wherein the set includes the second cell.

41. The method of claim 38 further comprising:
processing a radio resource control (RRC) configuration indicating a cell configuration for the second cell, wherein the cell configuration indicates that the UE-based TA estimation is allowed for the second cell.

42. The method of claim 38 further comprising:
processing a radio resource control (RRC) configuration indicating a set of cells of the plurality of cells and that the UE-based TA estimation is allowed for the set; and
determining that the second cell belongs to the set of cells.

43. The method of claim 38 further comprising:
processing a cell configuration and a measurement configuration, wherein the cell configuration indicates a configuration of the second cell, and wherein the measurement configuration is separate from the cell configuration and indicates that the UE-based TA estimation is allowed for the second cell.

44. An apparatus comprising:
processing circuitry configured to:
determine, while a first connection with a first cell of a plurality of cells is established, that a second cell of the plurality of cells is a candidate cell for a user equipment (UE)-based timing advance (TA) estimation;
perform, based on the second cell being a candidate cell, a timing measurement using a reference signal of the second cell;
process a command to establish a second connection with the second cell; and
perform the UE-based TA estimation by at least determining, after the command is received and based on a first TA of the first cell and the timing measurement, a second TA of the second cell.

45. The apparatus of claim 44, wherein the command includes a medium access control (MAC) control element (CE) associated with a handover to the second cell, wherein the MAC CE indicates the second cell and a trigger for the UE-based TA estimation.

46. The apparatus of claim 44, wherein the command includes a layer 1/layer 2 triggered mobility (LTM) switch indicating the second cell and a trigger for the UE-based TA estimation.

47. The apparatus of claim 44, wherein the command includes a medium access control (MAC) control element (CE) associated with a handover to the second cell and a layer 1/layer 2 triggered mobility (LTM) switch, wherein the MAC CE indicates a trigger for the UE-based TA estimation, and wherein the LTM switch indicates that the second TA is to be used for communications over the second connection.

48. The apparatus of claim 44, wherein the processing circuitry is further configured to:
generate, for transmission to a network, capability information indicating that a UE is capable to perform the UE-based TA estimation based on a measurement of a target cell's reference signal.

49. The apparatus of claim 48, wherein the capability information indicates at least one of:
the UE is capable to perform the measurement and derive a timing difference between two cells independently of whether the two cells use the same frequency;
an intra-frequency capability of the UE to perform the UE-based TA estimation for all target cells using the same frequency as a serving cell;
an intra-band capability of the UE to perform the UE-based TA estimation for all target cells using the same band as the serving cell;
a capability of the UE to perform the UE-based TA estimation for any band operating in a frequency division duplex (FDD) duplex manner or in a time division duplex (TDD) duplex manner;
a capability of the UE to perform the UE-based TA estimation for any band operating in a FR1 range, any band in a FR2-1 range, or any band in a FR2-2 range;
a band combination capability of the UE to perform the UE-based TA estimation for a combination of bands;
a per-band combination capability of the UE to perform the UE-based TA estimation for all target cells using a band combination as a serving cell;
a maximum number of cells for which the UE can perform reference signal measurements; or
a maximum number of frequencies for which the UE can perform reference signal measurements.

50. The apparatus of claim 44, wherein the processing circuitry is further configured to:
process a medium access control (MAC) control element (CE) that uses more than six bits to indicate a TA correction; and
update the second TA based on the TA correction.

51. The apparatus of claim 44, wherein the processing circuitry is further configured to:
process a random access response (RAR) medium access control (MAC) control element (CE) that indicates a TA correction, wherein the RAR MAC CE is received independently of a random access channel (RACH) procedure; and
update the second TA based on the TA correction.

52. The apparatus of claim 44, wherein the processing circuitry is further configured to:
determine that the second TA is beyond a capability of the UE; and
initiate a link recovery facility for layer 1/layer 2 triggered mobility (LTM).

53. A method comprising:
determining, while a first connection is established with a user equipment (UE) via a first cell of a plurality of cells; that a second cell of the plurality of cells is a candidate cell for a UE-based timing advance (TA) estimation;
generating, for transmission to the UE, a command to establish a second connection with the second cell;
foregoing sending a network-based TA to use for the second connection based on the second cell being a candidate cell;
establishing the second connection with the UE via the second cell; and
processing data received from the UE over the second connection, the data associated with a TA determined by the UE based on the UE-based TA estimation.

54. The method of claim 53 further comprising:
generating, for transmission to the UE, a radio resource control (RRC) configuration indicating a set of cells of the plurality of cells to be considered as candidate cells for the UE-based TA estimation, wherein the set includes the second cell.

55. The method of claim 53 further comprising:
generating, for transmission to the UE, a radio resource control (RRC) configuration indicating a cell configuration for the second cell, wherein the cell configuration indicates that the UE-based TA estimation is allowed for the second cell.

56. The method of claim 53 further comprising:
generating, for transmission to the UE, a radio resource control (RRC) configuration indicating a set of cells of the plurality of cells and that the UE-based TA estimation is allowed for the set, wherein the second cell belongs to the set of cells.

57. The method of claim 53 further comprising:
generating, for transmission to the UE, a cell configuration and a measurement configuration, wherein the cell configuration indicates a configuration of the second cell, and wherein the measurement configuration is separate from the cell configuration and indicates that the UE-based TA estimation is allowed for the second cell.
